(19) United States
(12) Patent Application Publication
(10) Pub. No.: US 2015/0012198 A1
(43) Pub. Date: Jan. 8, 2015

(54) DEVICE FOR CONTROLLING VEHICLE

(71) Applicant: DENSO CORPORATION, Kariya-city (JP)

(72) Inventor: Hidehiko Kumazawa, Nagoya-city (JP)

(21) Appl. No.: 14/299,262

(22) Filed: Jun. 9, 2014

(30) Foreign Application Priority Data
Jul. 5, 2013 (JP) 2013-141606

(51) Int. Cl. G05D 1/00; B60T 7/12

(52) U.S. Cl. CPC G05D 1/00; B60T 7/12
USPC 701/70; 701/1

(57) ABSTRACT

A device controls a vehicle moving around a parking lot and communicates a signal with a facility transceiver placed on the parking lot. The device comprises a vehicle transceiver installed in the vehicle that transmits the signal to the facility transceiver and receivers the signal from the facility transceiver. The device further comprises a determiner that determines a prohibited direction based on the signal communicated between the facility transceiver and the vehicle transceiver prior to a parking maneuver in the parking lot. The device further comprises a controller that regulates a movement of the vehicle if the vehicle is in the prohibited direction.

### CROSS REFERENCE TO RELATED APPLICATION

This application is based on reference Japanese Patent Application No. 2013-141606 filed on Jul. 5, 2013, the disclosure of which is incorporated herein by reference.

### TECHNICAL FIELD

The present disclosure relates to a device for controlling vehicle moving around a parking lot.

### BACKGROUND

Conventionally, as described in JP-A-2006-137223, the accident avoidance system makes drivers aware of their erroneous operation timely to avoid running away or tumbling down of the vehicle. The system includes a proximity determiner and an alert unit. The proximity determiner detects vehicle proximity to a marker placed outside the vehicle by receiving weak radio wave transmitted by the marker. The alert unit alerts the driver whether the vehicle is in a predefined proximity situation. Furthermore, the system also includes a brake controller for controlling a vehicle brake and an acceleration canceller for canceling an accelerating operation by the driver.

In the above-mentioned disclosure, any vehicle approaching in predefined area could receive a weak radio wave transmitted by the marker. Therefore, if multiple markers exist around the vehicle, the receiver installed in the vehicle could receive multiple weak radio waves from these markers respectively. It may activate the brake controller and/or the acceleration canceller despite a proper operation of the driver. Consequently, the driver could not operate the vehicle running and/or stopping according to their intention.

Moreover, the marker may lead to waste of power because the marker must keep on transmitting at a predefined power all the time regardless of presence of the vehicle.

The marker contains not only the transmitter but also a receiver that detects vehicle proximity at a close-in range, such as within several centimeters, to alert the driver audibly from outside of the vehicle. However, it might be too late to avoid colliding especially in the situation of the driver depresses the accelerator deeply and the vehicle is accelerated strongly. Thus, it is difficult for the vehicle to avoid colliding with a wall of building or parking.

### SUMMARY

It is an object of the present disclosure to produce a system for controlling a vehicle to protect the vehicle from accidents.

According to an aspect of the present disclosure, a system for controlling a vehicle moving around a parking lot, comprises a facility transceiver placed on the parking lot that transmits and receives a signal. The system further comprises a vehicle transceiver installed in the vehicle that transmits and receivers the signal. The system further comprises a determiner that determine a prohibited direction that prohibits the moving of the vehicle, when the vehicle is recognized, based on the signal that is communicated between the facility transceiver and the vehicle transceiver prior to a parking maneuver in the parking lot. The system further comprises a controller that regulates a movement of the vehicle so as not to move to the prohibited direction if the vehicle attempts to move toward the direction same as the prohibited direction determined by the determiner.

### BRIEF DESCRIPTION OF THE DRAWINGS

The above and other objects, features and advantages of the present invention will become more apparent from the following detailed description made with reference to the accompanying drawings. In the drawings:

FIG. 1 is a view showing an overview of a vehicle control system;

FIG. 2 is a view showing a diagram of a facility transceiver;

FIG. 3 is a view showing a block diagram of a vehicle transceiver;

FIG. 4 is a view showing a block diagram of a vehicle;

FIG. 5 is a view showing a frame format of a signal;

FIG. 6 is a flowchart showing a detection flow of a determiner;

FIG. 7 is a flowchart showing a transceiver flow of the facility transceiver;

FIG. 8 is a flowchart showing the first procedure of a vehicle control;

FIG. 9 is a view showing an example of a head-in parking;

FIG. 10 is a view showing an example of a back-in parking;

FIG. 11 is a flowchart showing the second procedure of the vehicle control;

FIG. 12 is a flowchart showing the third procedure of the vehicle control; and

FIG. 13 is a flowchart showing another procedure of a sequential part.

### DETAILED DESCRIPTION

An embodiment of the disclosure will be described referring to the drawings. The word “connect” in the specification may represent to connect electrically between components unless mentioned specifically. Not all actual elements may imply description is not concrete. Directions indicated in this specification maybe not to take risk due to unintentional rotation of the drawings. The word “information” includes a signal, data and the like.

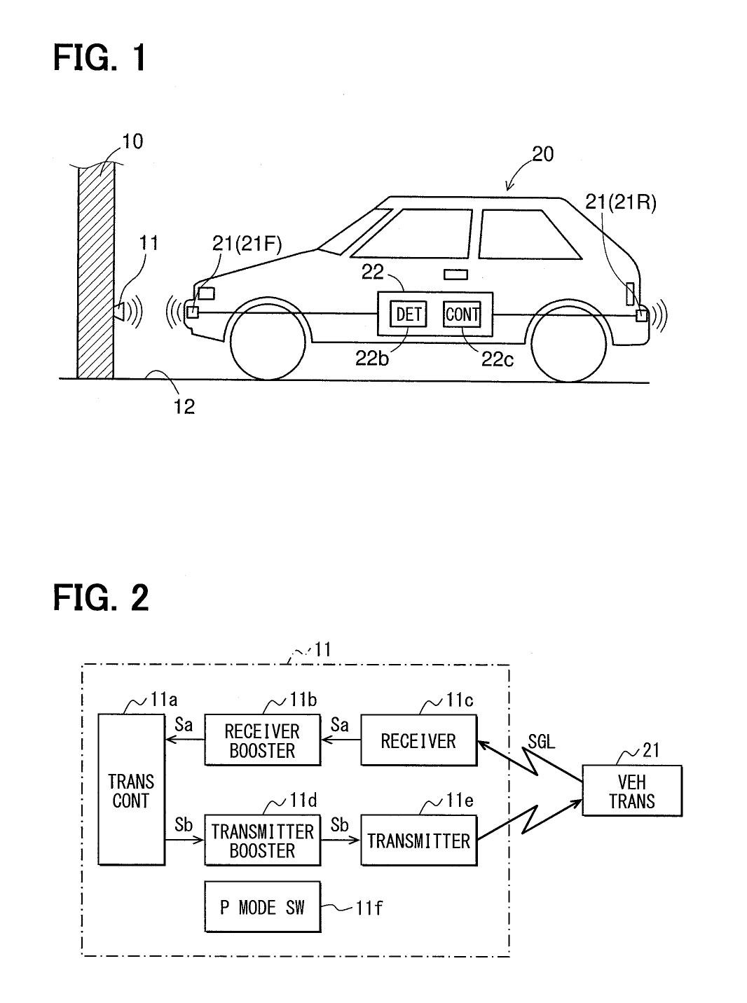

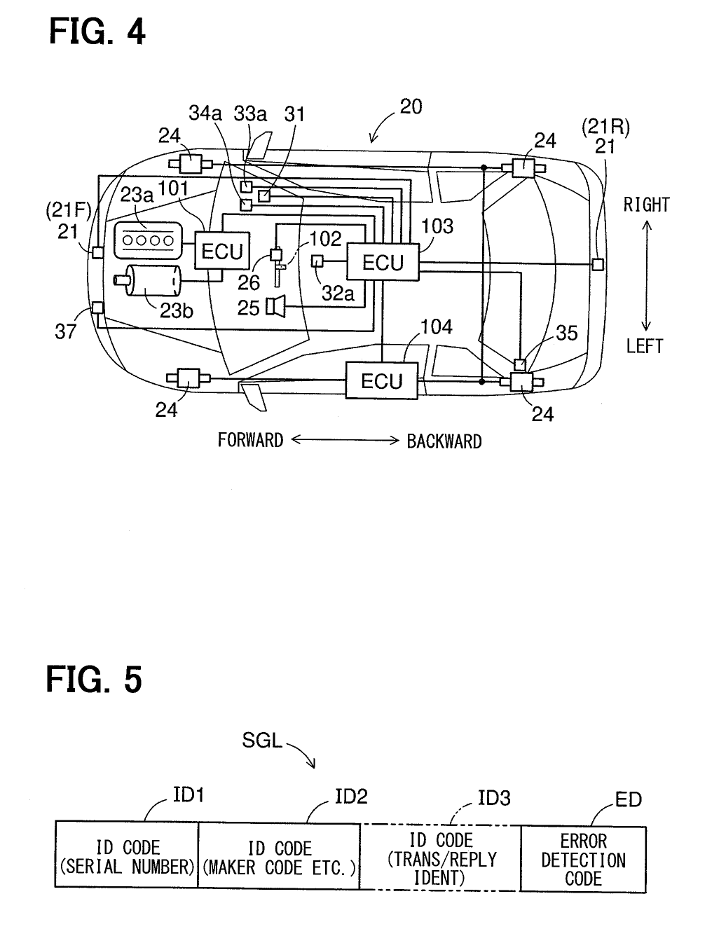

The first embodiment is described by referring to FIGS. 1 to 10. As shown in FIG. 1, a vehicle control system includes a facility transceiver 11, a vehicle transceiver 21 (21F, 21R), a determiner 22b, and a controller 22c. The facility transceiver 11 is enabled to transmit and to receive a signal SGL and is placed on a parking lot 12. In the example of FIG. 1, a facility transceiver 11 is placed on a facility equipment 10. The facility transceiver 11 and the signal SGL are described later with reference to FIG. 2 and FIG. 4. The vehicle transceiver 21 is installed in the vehicle and is enabled to transmit and to receive the signal SGL. The vehicle transceiver 21 includes a front vehicle transceiver 21F on the front of and a vehicle 20 and transceiver 21R on the rear of the vehicle 20.

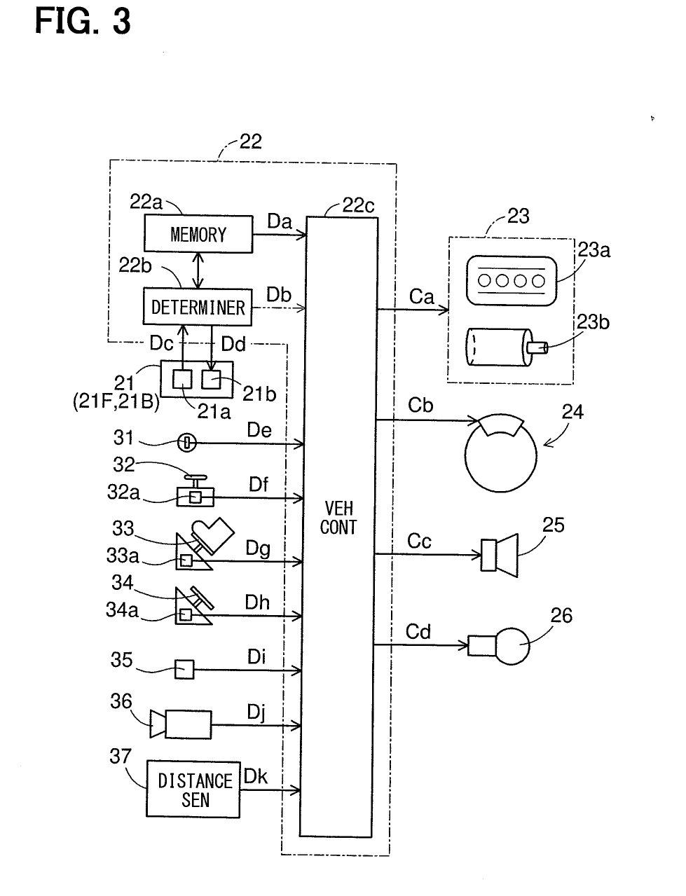

The determiner 22b determines a prohibited direction in which a movement of the vehicle is prohibited. When the vehicle 20 is recognized, the determiner 22b determines the prohibited direction based on the signal that is communicated between the facility transceiver and the vehicle transceiver prior to a parking maneuver in the parking lot 12. The controller 22c regulates the movement of the vehicle 20 caused by the driver in the same direction as the prohibited direction. In this embodiment, a driving control unit 22 includes the determiner 22b and the controller 22c (FIG. 3).

As shown in FIG. 2, the facility transceiver 11 includes a transceiver control unit 11a, a receiver booster 11b, a receiver unit 11c, a transmitter booster 11d, a transmitter unit 11e, and a power mode switch 11f. Each element of the facility transceiver 11 is described below.

The receiver unit 11c receives the signal SGL transmitted by the vehicle transceiver 21. The receiver booster 11b boosts a received signal Sa, corresponding to the signal SGL received by the receiver unit 11c, and sends the boosted received signal Sa to the transceiver control unit 11a. A boosting rate set by the receiver booster 11b may be adjustable to enable the transceiver control unit 11a to process the receiving signal Sa. The transceiver control unit 11a performs a control to output a transmitted signal Sb based on the signal Sa sent from the receiver booster 11b. The transmitter booster 11d boosts the transmitted signal Sb outputted by the transceiver control unit 11a and sends the boosted transmitted signal Sb to the transmitter unit 11e. The transmitter unit 11e transmits the signal SGL corresponding to the boosted signal boosted by the transmitter booster 11d. A boosting rate set by the transmitter booster 11d may be adjustable to enable the transceiver 21 as a transceiver control unit to receive the signal SGL.

The power mode switch 11f switches a mode between a normal power mode and a lower power mode. The normal power mode is responsible to be continued for a time period from receiving the signal SGL from the transceiver 21 until finishing transmitting the signal SGL to the transceiver 21. The lower power mode is responsible for enabling the facility transceiver 11 to receive the signal SGL from the vehicle transceiver 21 wherein the power is lower than that of the normal power mode.

The driving control unit 22 as shown in FIG. 3 includes a memory 22a, a determiner 22b, and a controller 22c. Each element of the driving control unit 22 is described below.

The memory 22a stores a result of detection of the determiner 22b, such as the prohibited direction. The memory 22a stores an identification code ID1, ID2 (refer to FIG. 5) that is included in the signal SGL and various other data. The memory 22a may temporarily store the information and may permanently store the information. The various other data may include, for example, various kinds of data given by sensors, a temporary data temporarily stored prior to output to a power generator 23 or a brake device 24, and a temporary data recorded to be processed. The memory 22a may include a storage for recording each data and could be at least one of a non-volatile semiconductor memory, such as a flash memory encompassing a solid state drive (SSD), a hard drive, an optical drive (includes an magneto-optical disc), a flexible disc, and a RAM. It may be preferable to employ a non-volatile memory that keeps data if a power source shuts down. Moreover, a memory in an electronic control unit (ECU, refer to FIG. 4) may be used together with or substitute for the memory 22a.

Above-described sensors may include, for example, an ignition switch 31, a shifter position sensor 32a, an accelerator position sensor 33a, a decelerator position sensor 34a, a speed sensor (velocity sensor) 35, a camera 36, and/or a distance sensor 37.

The shifter position sensor 32a detects an operated shift position of a shifter 32, such as Park, Reverse, Drive, Second gear, and First gear, and outputs the detected shift position as a shift position data Df. The accelerator position sensor 33a detects a position (a stroke volume) of an acceleration pedal 33 and outputs the detected accelerator position as an accelerator position data Dg. The decelerator position sensor 34a detects a position (a stroke volume) of a brake pedal and outputs the detected decelerator position as a decelerator position data Dh. The speed sensor 35 detects the vehicle speed and outputs the detected vehicle speed as a vehicle speed data Di. The distance sensor 37 detects a distance to an object and outputs the detected distance as a distance data Dk. The camera 36 captures a still picture or a motion picture and outputs the captured picture as an image data Dj. The distance sensor 37 may be sonar or radar. Alternatively, the distance sensor 37 may be produced as an analysis result based on an image data Dj captured by the camera 36.

The determiner 22b recognizes the vehicle and determines the prohibited direction in which a movement of the vehicle is prohibited based on the signal SGL transceived between the transceiver 21 and the facility transceiver 11. The transceiver 21 includes a receiving unit 21a and a transmitting unit 21b.

Specifically, the determiner 22b makes a decision based on a received information Dc that is included in the signal SGL. The signal SGL is transmitted by the facility transceiver 11 and received at the receiving unit 21a, after a transmitted data Dd is sent to the transmitting unit 21b and is transmitted to the facility transceiver 11. The signal SGL includes an identifier code unique to the vehicle 20. The signal SGL may include an identifier code ID1 described with reference to FIG. 5. The vehicle recognition and the prohibited direction determination are based on communications between a front vehicle transceiver 21F and a rear vehicle transceiver 21F. The determiner 22b recognizes the vehicle as a subject vehicle when the identifier codes transmitted to and received from the facility transceiver 11 are identical with each other; otherwise, the determiner 22b recognizes the vehicle as another vehicle. The determiner determines the prohibited direction based on whether the signal SGL is receivable by at least one of the front vehicle transceiver 21F and the rear vehicle transceiver 21F. In other words, the determiner 22b determines the vehicle heading forward based on the signal SGL received by the front vehicle transceiver 21F or determines the vehicle reversing back based on the signal SGL received by the rear vehicle transceiver 21F. In contrast, the determiner 22b determines the vehicle being in no direction based on no signal from both the front vehicle transceiver 21F and the rear vehicle transceiver 21F. A result of the determination is recorded in the memory 22a as a recorder.

The controller 22c regulates the movement of the vehicle in a usual condition and under a movement regulating condition that the controller 22c regulates the movement of the vehicle. The movement regulating condition is predefined arbitrary, and may be, for example, at least one of conditions as follows. Firstly, the at least one condition may be satisfied after completion of the parking maneuver (includes stopping the vehicle), in other words, the vehicle velocity, based on a vehicle speed data Di detected by the speed sensor 35, is substantially equal to 0 km/h. Secondly, the vehicle attempts to move in the same direction as the prohibited direction. Thirdly, a change Δd per unit time based on the position of the acceleration pedal 33 (a step-in degree data Dg detected by the accelerator position sensor 33a) exceeds a threshold Th. The threshold is predefined as an arbitrary value. If the threshold is set as 0, a step-in degree data Dg exceeds the threshold even by stepping-in just within a play. The conditions may include another condition that is set accordingly to regulate the movement of the vehicle as necessary.

The regulation control includes controlling deceleration, stop, and others of the vehicle, for specific example, at least one of controls as follows. First, the controller 22c transmits a power data Ca to a power source as a power generator 23 to regulate the movement of the vehicle. The power generator 23 includes at least one of an internal combustion engine 23a and an electrical rotating machine 23b. The electrical rotating machine 23b includes, for example, an electrical motor-generator, an electrical motor, and an electrical generator. Second, the controller 22c transmits a brake data Cb to a brake device 24 to activate brake actuators. Third, the controller 22c transmits a warning sound data Cc to a speaker 25 to output sounds such as a voice warning or transmits warning lamp data Cd to a warning lamp 26 to turn on the warning lamp 26. Arbitrary light device such as LED could be applicable for the warning lamp 26. Moreover, a console, a meter, a navigation system could be used to display or illuminate letters and/or images as a warning to the driver.

Next, an example for a construction of the vehicle is described with reference to FIG. 4. The vehicle 20 may be a reciprocating engine vehicle, a hybrid vehicle, and an electric vehicle. The vehicle 20 may include the vehicle transceiver 21 (21F and 21R), the power generator 23, such as the internal combustion engine 23a and the electrical rotating machine 23b, the brake device 24, the speaker 25, the warning lamp 26, the ignition switch 31, the accelerator position sensor 33a, the decelerator position sensor 34b, the speed sensor 35, the camera 36, the distance sensor 37, and the ECUs 101, 103, 104. Some of elements of the vehicle may be omitted in the drawings. The speed sensor 35 is mounted to, for example, left rear wheels in the drawing. Alternatively, the speed sensor 35 may be mounted to any other wheels, or the speed sensor 35 may be mounted each to all wheels. The arrangement of the elements as shown in the drawing is just for example, so the elements may be mounted on arbitrary in the vehicle 20 as long as it is legal.

In an example as shown in FIG. 4, the ECUs 101, 103, and 104 perform distributed processing according to the purpose of control. The ECU 103 controls the whole ECU and manages various kinds of sensor. The ECU 101 is included in the power generator 23 and controls an actuation of the internal combustion engine 23a and the electrical rotating machine 23b. The ECU 104 controls the brake device 24 based on the brake data Cb transmitted from the ECU 103. Moreover, the vehicle 20 may further include an ECU controls at least one of the power sources, such as a rechargeable battery, a fuel cell, and a solar cell. In addition, the vehicle 20 may further include an ECU controls an airbag and/or a seatbelt.

The signal SGL as shown in FIG. 5 is an example format communicated between the facility transceiver 11 and the vehicle transceiver 21. The signal SGL includes the identification code ID1, ID2 and/or an error detection code ED. The signal SGL may be a wireless signal such as radio wave, infrared rays, visible rays, or ultraviolet rays. The identification code ID1 is information peculiar to the vehicle 20, such as a serial number, a VIN number, and/or an engine number. The identification code ID2 added as necessary is information relating to the vehicle 20, such as a manufacturer name (code), a vehicle name (code), and/or an engine model. The error detection code ED is used for detecting or correcting errors contained in the identification code ID1 and/or ID2 caused by an exogenous noise. The error detection code is preferably formed by, for example, an interleaving technology to avoid concentration of burst errors.

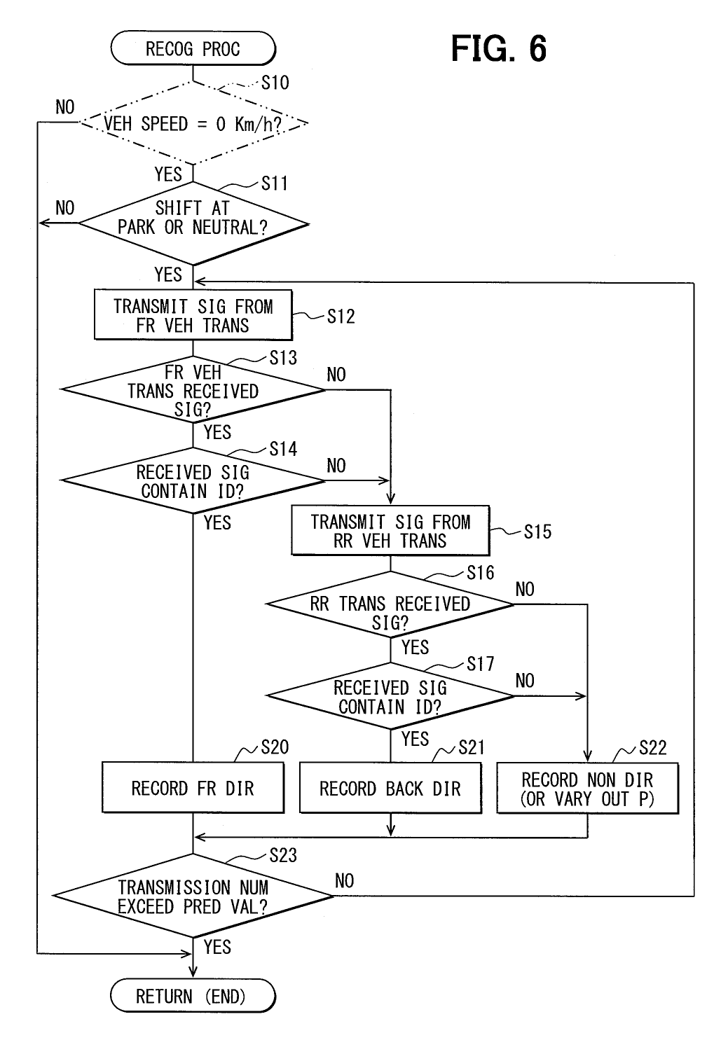

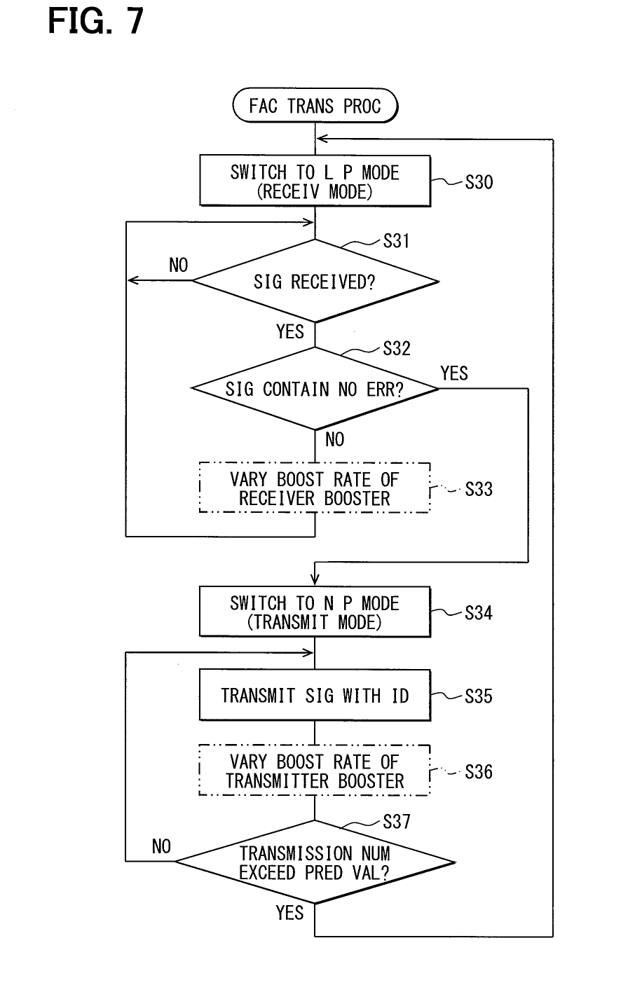

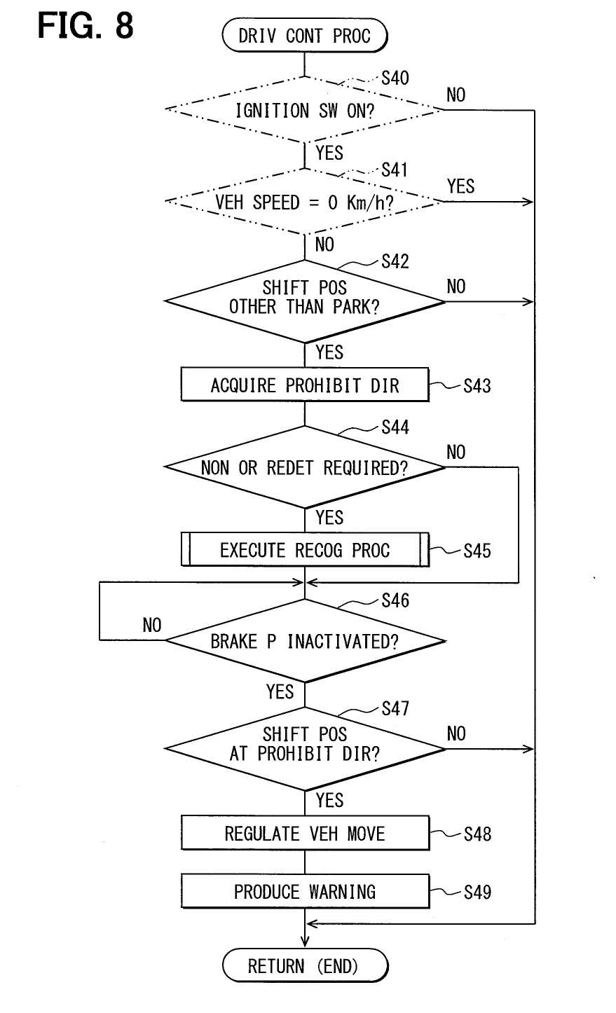

A recognition process as shown in FIG. 6 and a driving control process as shown in FIG. 8 are examples for procedures to be performed by the driving control unit 22. A transceiver process as shown in FIG. 7 is an example for a procedure to be performed with the facility transceiver 11, specifically the transceiver control unit 11a. Next is a description for each above process in detail. The recognition process may correspond to determiner 22b, and the driving control process may correspond to the controller 22c. Each of the processes repeats as long as power is active. A step of Return as shown in flow charts may also include a step of end of the processes.

In the recognition process as shown in FIG. 6, the determiner 22b determines whether the vehicle stops based on whether the vehicle speed data Di indicates 0 km/h (S10). S10 may be performed as necessary. The determiner 22b also determines whether the shifter 32 is positioned at Park or Neutral based on the shift position data Df sent from the shifter position sensor 32a (S11). The steps S10 and S11 are processed in no particular order. The recognition process proceeds to Return when the vehicle 20 does not stop (the vehicle speed is greater than 0 km/h, S10: No) or the shifter 32 is positioned at a position other than Park or Neutral (S11: No).

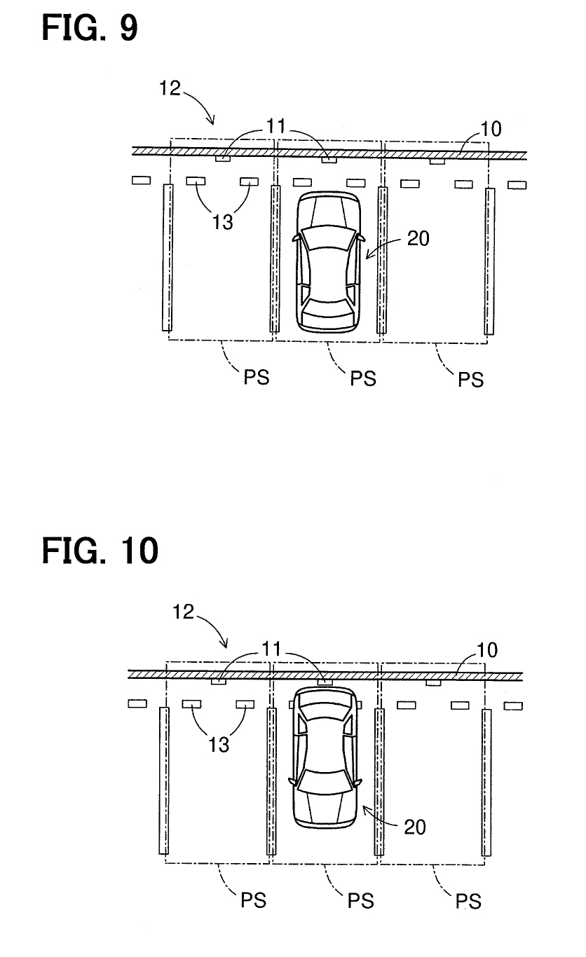

The transceiver process of the signal SGL is performed when the vehicle 20 stops, that is, when the vehicle speed is 0 km/h (S10: Yes), or the sifter 32 is positioned at Park or Neutral (S11: Yes). The transceiver process is performed to determine whether the vehicle 20 parks at a parking space PS in forward direction as shown in FIG. 9 or in backward direction as shown in FIG. 10 as described below. Steps S12 through S14 and steps S15 through S17 may be performed in no particular order.

The front vehicle transceiver 21F mounted on the front of the vehicle 20 transmits the signal SGL (S12) and determines whether to receive (or respond) the signal SGL transmitted from the facility transceiver 11 (S13). The front vehicle transceiver 21F receives the signal SGL when the vehicle 20 parks in forward direction as shown in FIG. 9, but not when the vehicle 20 parks in backward direction as shown in FIG. 10. Then the direction “forward” is stored in the memory 22a, as the prohibited direction (S20), when the signal SGL is received from the facility transceiver 11 (S13: Yes) and when the signal SGL contains the identification code ID1, ID2 of the subject vehicle (S14: Yes).

On the other hand, when the signal SGL is not received from the facility transceiver 11 (S13: No) or when the signal SGL does not contain the identification code ID1, ID2 of the subject vehicle (S14: No), the rear vehicle transceiver 21F mounted on the rear of the vehicle 20 transmits the signal SGL (S12). The rear vehicle transceiver 21R determines whether to receive (or respond) the signal SGL transmitted from the facility transceiver 11 (S16). The rear vehicle transceiver 21R receives the signal SGL when the vehicle 20 parks in backward direction as shown in FIG. 10, but not when the vehicle 20 parks in forward direction as shown in FIG. 9. Then the direction “backward” is stored to the memory 22a as the prohibited direction (S21) when the signal SGL is received from the facility transceiver 11 (S16: Yes) and the signal SGL contains the identification code ID1, ID2 of the subject vehicle (S17: Yes).

When neither the front vehicle transceiver 21F nor the rear vehicle transceiver 21R receives the signal SGL (S13, S16; No), or when the signal SGL does not contain the identification code ID1 or ID2 (S14, S17: No), the direction “none” is stored in the memory 22a (S22). In step S22, the transmission power may be varied to increase in case of a power lack, for example, when the facility transceiver 11 cannot receive the signal SGL from the vehicle transceiver 21.

The above-described steps S12 to S22 are repeated as long as the facility transceiver 11 transmits the signal SGL within a predefined times (S23: No). On the other hand, when the number of times of transmitting of the signal SGL to the facility transceiver 11 exceeds the predefined times (S23: Yes), the recognition process returns to the step S12. The predefined times are set arbitrary. The determination indicates the prohibited direction such as “forward”, “backward”, and “none” could be intermingled with each other due to wall reflections of the signal SGL. In such case, an identification code ID3 may be added to the signal SGL to indicate that the signal SGL is a transmitted signal as shown in FIG. 5. In addition, it may also be applicable to take a majority decision among the determinations, the first decision among the determinations, or the last decision among the determinations. The length of the identification code ID3 may be set arbitrarily as long as it is more than one bit. Moreover, the transmission power of the signal SGL transmitted by the vehicle transceiver 21 might also be varied to decrease.

In a facility transceiver process as shown in FIG. 7, the power mode switch 11f switches the power mode to the lower power mode (S30) and the facility transceiver 11 waits for the signal SGL transmitted from the vehicle transceiver 21 (S31: No). If the received signal Sa based on the signal SGL contains error (S32: No), the facility transceiver 11 waits for the signal SGL transmitted from the vehicle transceiver 21 next time (S31: Yes). In the decision at step S32, an analog to digital conversion sometimes fails due to a large power fluctuation in the received signal Sa. Therefore the signal SGL received by the receiver booster 11b is boosted with varying the boosting ratio to increase or decrease (S33).

The power mode switch 11f switches the power mode to the normal power mode (S34) when the signal SGL received by the receiver unit 11c has no error (S32: Yes). The facility transceiver 11 outputs the transmitting signal Sb with containing the identification code ID1 and ID2, and transmits (or responds) the signal SGL based on the transmitting signal Sb to the vehicle transceiver 21 (S35). If the signal SGL has not contained the identification code ID3 that represents that the signal SGL is transmitted from the vehicle transceiver 21, the signal SGL is preferable to be added with the identification code ID3 to represent that the signal SGL is replied from the facility transceiver 11. On the other hand, if the signal SGL has already contained the identification code ID3 that indicates that the signal SGL is transmitted from the vehicle transceiver 21, the signal SGL may be replaced it with the identification code ID3 that indicates that the signal SGL is responded from the facility transceiver 11. If the vehicle transceiver 21 cannot receive the signal SGL due to the large power fluctuation of the signal SGL based on the transmitting signal Sb, the transceiver booster 11d is preferable to boost the transmitting signal Sb with varying the boosting ratio to increase or to decrease (S36).

The steps S35 and S36 are repeated for a predefined times to transmit the signal SGL to the vehicle transceiver 21 (S37: No). On the other hand, when the number of times of the transmission exceeds the predefined value (S37: Yes), the facility transceiver process returns to step S30 and repeats. The predefined value may be set arbitrary. The predefined value may not matter if it is the same as of step S23 or not.

In the driving control process as shown in FIG. 8, it is determined whether the ignition switch 31 turns on or not based on an ignition data De (S40). The step S40 may be performed as necessary. It is determined whether the vehicle speed is 0 km/h or not based on the vehicle speed data Di sent form the speed sensor 35 (S41). The step S41 may be performed as necessary. It is also determined whether the shifter 32 is positioned at a position other than Park or not based on the shifter position data Df sent from the shifter position sensor 32a (S42).

The driving control process proceeds to Return when the ignition switch 31 is turned off (S40: No), when the vehicle speed is 0 km/h (S41: Yes), or when the shifter 32 is positioned at Park (S42: No).

Conversely, the vehicle is in drivable condition when the ignition switch 31 is turned on (S40: Yes), when the vehicle speed exceeds 0 km/h (S41: No), and when the shifter 32 is positioned at a position other than Park (S42: Yes). Then the controller 22c acquires the prohibited direction stored in the memory 22a (S43).

If the prohibited direction acquired at step S43 is “none” or required redetermination (S44: Yes), the recognition process as shown in FIG. 6 is re-performed to acquire the prohibited direction (S45). Situations to be required the redetermination is set arbitrary. For example, one situation may occur when a parking direction and a departure direction are different from each other in the parking lot 12 installed with a turntable. The recognition process of step S45 is premised on the sifter 32 positioned at a position other than Park. Thus, step S11 is not performed or ignored due to a contra-direction to step S45.

The driving control process stands by during the vehicle 20 stops as a result of the brake pedal 34 being pressed down based on the decelerator position data Dh sent from the decelerator position sensor 34a when the prohibited direction is acquired at step S43 or when the redetermination is required at step S45 (S46: No).

When the brake pedal is inactivated or not pressed down (S46: Yes), the vehicle starts to move. Thus, the driving controller 22c determines whether the vehicle moves in the same direction as the prohibited direction (S47). Specifically, the driving controller 22c determines whether the vehicle 20 moves in the prohibited direction, which is acquired at step S43 or re-determined at step S45, based on the shifter data Df sent from the shifter position sensor 32a. If the vehicle 20 does not move in the prohibited direction (S47: No), the driving control process proceeds to Return because the vehicle 20 is not directed to objects in the parking lot 12, such as a wall, a fence, a pole, and/or a tree.

If the vehicle 20 moves in the prohibited direction (S47: Yes), the vehicle 20 is controlled to regulate the movement (S48) and the warning to the driver is produced because the vehicle 20 is directed to an object in the parking lot 12. In other words, the vehicle 20 is controlled to avoid colliding with an object in the parking lot 12 in case of possibility of an erroneous operation made by an occupant.

Specifically, as an example for step S48, the vehicle 20 is controlled to regulate the movement by sending the power data Ca to the power generator 23 and/or to activate the brake actuators by sending a brake data Cb to the brake device 24. An operation quantity of the brake device 24 may be strengthened according to increase in the position of the accelerator pedal 33 based on the step-in degree data Dg. Operation of the accelerator pedal 33 may also be invalidated despite an operation of the driver. Operation of the shifter 32 in the prohibited direction may also be invalidated. The movement of the vehicle 20 may be regulated until the shifter 32 is positioned at a position, which does not coincide with other than the prohibited direction. As exemplified above, the vehicle may be regulated to avoid colliding with the objects in the parking lot 12.

As shown in FIG. 9, for example, when the vehicle 20 parks in the parking space PS in the forward direction, the vehicle 20 is controlled to regulate the movement by executing step S48 if the vehicle 20 moves forward as a result of the shifter 32 being positioned at Drive, Second gear, or First gear. As shown in FIG. 10, similarly, when the vehicle 20 parks in the parking space PS in the backward direction, the vehicle 20 is controlled to regulate the movement by executing step S48 if the vehicle 20 moves backward as a result of the shifter 32 being positioned at Reverse, etc.

As an example for step S49, the speaker 25 produces sound or voice by sending the warning sound data Cc, or the warning lamp 26 turns on by sending the warning lamp data Cd. It may also be available to display letters or images in a console, meters, and navigation. It may also be effective to turn on interior lights. Any other warning method may also be employed to make the occupant recognize their erroneous operation.

According to above-described embodiment 1, each effect shown below is given accordingly.
(1) A device for controlling vehicle moving around a parking lot 12 and for communicating a signal SGL with a facility transceiver 11 placed on the parking lot, comprises: a vehicle transceiver 21 installed in the vehicle 20 that transmits the signal SGL to the facility transceiver 11 and receivers the signal from the facility transceiver 11; a determiner 22b that determines a prohibited direction based on the signal SGL communicated between the facility transceiver 11 and the vehicle transceiver 21 prior to a parking maneuver in the parking lot 12; and a controller 22c that regulates a movement of the vehicle 20 if the vehicle 20 is in the prohibited direction (FIG. 1 through 10). According to the above, the determiner 22b performs the determination of the prohibited direction only when the vehicle 20 is recognized such that the movement of the vehicle 20 is not regulated unnecessarily. If the vehicle 20 is in the prohibited direction determined by the determiner 22b, the movement of the vehicle 20 is controlled by the controller 22c. Therefore, the vehicle 20 avoids colliding with an object in a parking lot 12 more reliably than a conventional one and enables the movement to run or to stop according to the driver's intention.
(2) The facility transceiver 11 further comprises a switch 11f that switches a power mode between a normal power mode and a lower power mode, wherein the normal power mode is responsible to be continued for a time period from receiving the signal from the vehicle transceiver 21 until finishing transmitting the signal to the vehicle transceiver 21, wherein the lower power mode is responsible for enabling receiving the signal from the vehicle transceiver 21 with a power lower than that of the normal power mode (FIGS. 2 and 7). According to the above, the normal power mode is applied during the signal SGL is transmitted to the vehicle transceiver 21 and the lower power mode is applied during the signal SGL is received from the vehicle transceiver 21. In general, a duration for transmitting the signal SGL is far shorter than duration for receiving the signal. Thus, it regulates a waste of power.
(3) The facility transceiver 11 further comprises at least one of a receiver booster 11b that boosts the signal SGL received from the vehicle transceiver and a transmitter booster 11d that boosts the signal SGL transmitted to the vehicle transceiver (SS33 and S37 in FIGS. 2 and 7). According to the above, the facility transceiver 11 communicates the signal SGL with the vehicle transceiver 21 certainly.
(4) The vehicle transceiver 21 varies an output of the signal SGL transmitted to the facility transceiver 11. According to the above, the vehicle transceiver 21 communicates the signal SGL with the facility transceiver 11 certainly.
(5) The determiner 22b starts communication of the signal SGL between the vehicle transceiver 21 and the facility transceiver 11 after a shifter 32 of the vehicle 20 is positioned at Park or Neutral. In general, the shifter 32 is positioned at Park or Neutral to complete a parking maneuver (S22 in FIGS. 1, 3, and 6). According to the above, the determiner 22b determines the prohibited direction certainly, because the signal SGL is communicated right before the parking maneuver.
(6) The determiner 22b includes a vehicle identifying code ID in the signal SGL communicated with the facility transceiver 11 (FIG. 5). According to the above, the determiner 22b recognizes whether the signal SGL is transmitted by the vehicle transceiver 21. In other words, the determiner 22b determines easily whether the vehicle 20 is recognized. Thus, it avoids an unintentional communication with the facility transceiver 11 and enables the movement to run or to stop of the vehicle 20 according to the driver's intention.
(7) The determiner 22b identifies the vehicle 20 based on an authentication of the vehicle identifying code ID between the transmitted signal and the received signal (S14 and S17 in FIG. 6). According to the above, the determiner 22b recognizes whether the signal SGL is from own vehicle or the other vehicle since the vehicle identifying code ID is different depending on the vehicle 20.
(8) The signal SGL communicated between the vehicle transceiver 21 and the facility transceiver 11 includes an error detecting code ED (FIG. 5). According to the above, the signal is corrected by using the error detection code ED even if an error occurs in the signal SGL due to an exogenous noise.
(9) The determiner 22b determines the prohibited direction when an ignition switch 31 turns on after the parking maneuver (S40 and S45 in FIG. 8). According to the above, the determiner 22b determines the prohibited direction not only before the parking maneuver but also after the parking maneuver. Thus, it is also applicable for a parking lot 12 with a turntable.
(10) The controller 22c warns the driver audibly by using a speaker 25 and/or visually by using a warning lamp 26 (S49 in FIG. 8). According to the above, an occupant is enabled to recognize that the vehicle 20 is in the prohibited direction and to take steps quickly to change the direction of the vehicle to the opposite.
(11) The controller 22c regulates the movement of the vehicle 20 if the shifter 32 is positioned at a position corresponding to the prohibited direction (S47 and S48 in FIG. 8). The vehicle 20 may collide possibly with an object in a parking lot 12 when the vehicle 20 runs with the shifter 32 positioned at the prohibited direction. According to the above, the movement of the vehicle 20 is regulated based on a position of the shifter 32 to avoid colliding with the object in the parking lot 12.
(12a) The controller 22c regulates the movement of the vehicle 20 when at least one of following conditions is satisfied: a brake pedal 34 is inactivated; and the vehicle speed is higher than 0 km/h (S46 and S48 in FIG. 8). According to the above, the controller 22c regulated the movement of the vehicle 20 as long as the brake pedal 34 is inactivated or not pressed down. Thus, the vehicle 20 avoids colliding with an object in the parking lot 12 more certainly than conventional one.
(13) The controller 22c regulates the movement of the vehicle 20 when an accelerator pedal 33 is pressed down (S48 in FIG. 8). According to the above, the controller 22c regulates the movement of the vehicle 20 in spite of the fact that an accelerator pedal 33 is pressed down in operational error.
(14) The controller 22c activates a brake actuator that brakes the movement of the vehicle 20 (S48 in FIG. 8). According to the above, the vehicle 20 avoids colliding with an object in the parking lot 12 by actuating the brake device 24.
(15) The controller 22c increases a magnitude of braking according to increase in manipulation at the accelerator pedal 33 (S48 in FIG. 8). According to the above, the controller 22c increases a magnitude of braking according to increase in manipulation at the accelerator pedal 33. Thus, the movement of the vehicle 20 unexpected by an occupant is avoided previously.
(16) The controller 22c regulates the movement of the vehicle 20 based on determination of the determiner 22b when the ignition switch 31 turns on (S40 and S48 in FIGS. 6 and 8). According to the above, the determiner 22b determines the prohibited direction before a parking maneuver but not after a parking maneuver. The controller 22c regulates the movement of the vehicle 20 when the vehicle 20 is in the prohibited direction after the ignition switch 31 turns on.

### Second Embodiment

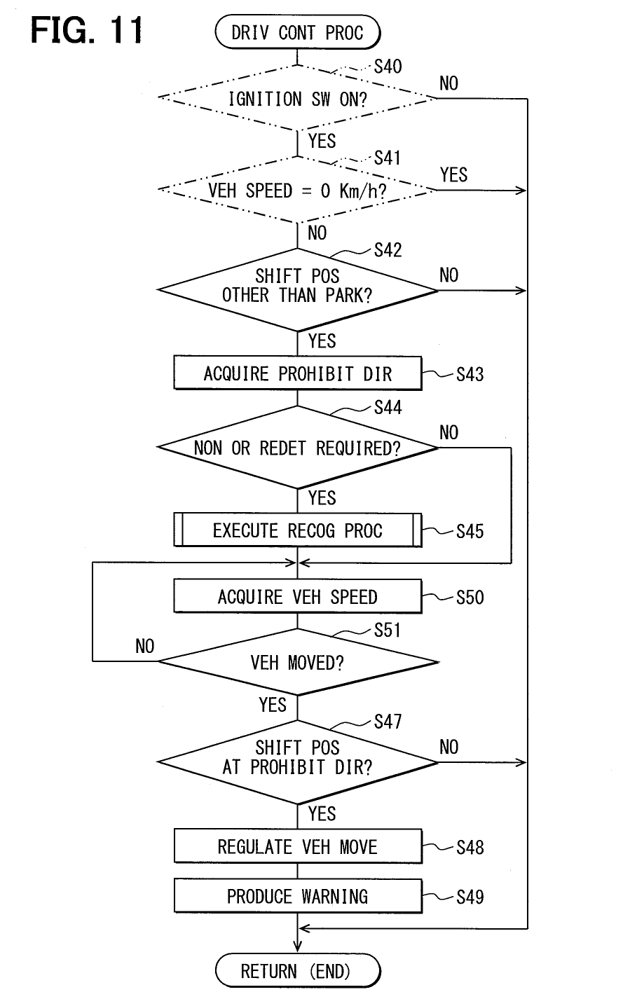

The second embodiment is described with reference to FIG. 11. To simplify an illustration and a description, the same elements as in the first embodiment are numbered with the same numerals and are omitted their detailed description unless otherwise stated.

The process as shown in FIG. 11 is an example for an alternative driving control process to the process in FIG. 8. In this process, the difference is that steps S50 and S51 in FIG. 11 are performed alternative to steps S46 in FIG. 8. The vehicle speed data Di is given by the speed sensor 35 (S50) and a determination is made whether the vehicle 20 runs (moves) or not based on the vehicle speed data Di (S51). In other words, the vehicle 20 is determined not to run when the vehicle speed data Di indicates 0 km/h (S51: No), or the vehicle 20 is determined to run when the vehicle speed data Di indicates a speed other than 0 km/h (S51: Yes).

The vehicle 20 is controlled to regulate the movement when the vehicle 20 moves at a speed higher than 0 km/h based on the vehicle speed data Di (S51: Yes) and when the vehicle moves in the prohibited direction (S47: Yes).

According to the above-described second embodiment, each effect shown below is given accordingly. Since the structure of the driving control system is basically the same as the first embodiment, the same effects are given except an effect described at (12a).
(12b) The controller 22c regulate the movement of the vehicle 20, when the vehicle 20 moves, based on the acquired speed signal. According to the above, the controller 22c regulates the movement of the vehicle 20 when the vehicle 20 starts to move due to the accelerator pedal 33 pressed down or the parking lot with inclined floor surface.

### Third Embodiment

The third embodiment is described with reference to FIG. 11. To simplify an illustration and a description, the same elements as in the first and the second embodiments are numbered with the same numerals and are omitted the detailed description unless otherwise stated.

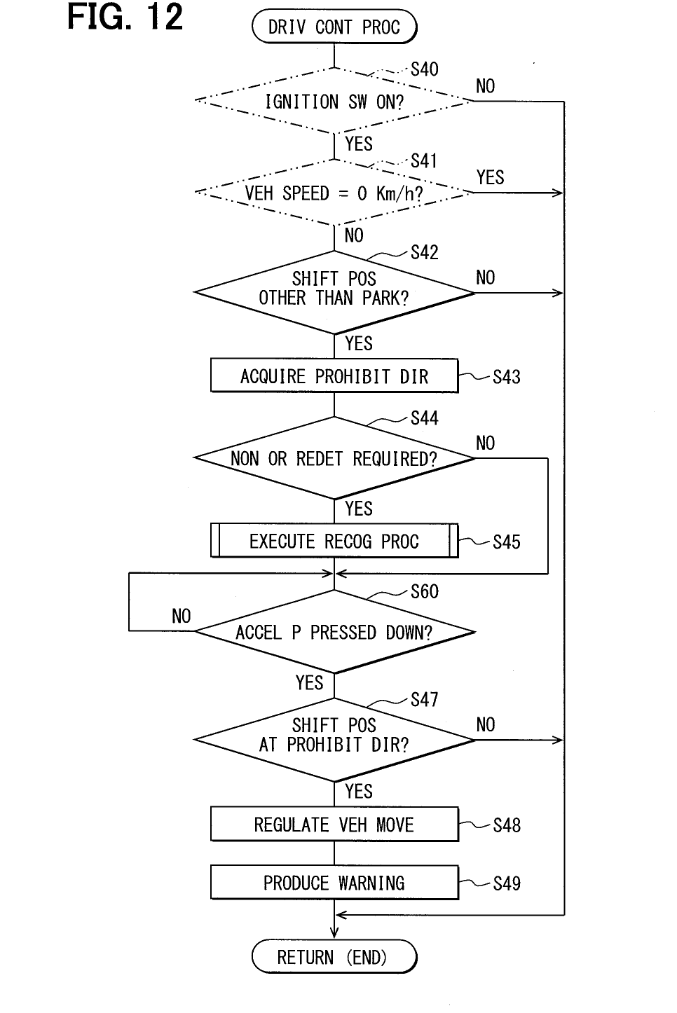

The process as shown in FIG. 12 is an example for an alternative driving control process to the process shown in FIG. 8. In this process, the difference is that S60 in FIG. 12 is performed alternative to S46 in FIG, 8. In S60, a determination is made whether the accelerator pedal 33 is pressed down or not based on the step-in degree data Dg sent from a degree sensor as an accelerator position sensor 33a. The process is on standby during the accelerator pedal 33 is not pressed down because the vehicle 20 does not move (S60: No).

The regulation of the movement of the vehicle 20 is performed when the accelerator pedal 33 is pressed down and when the vehicle 20 moves in the prohibited direction (S47: Yes).

According to the above-described third embodiment, each effect shown below is given accordingly. Since the structure of the driving control system is basically the same as the first embodiment, the same effects are given except an effect described as (12a).
(12c) The controller 22c regulates the movement of the vehicle 20 when a condition is satisfied that the accelerator pedal 33 is pressed down (S60, S48 in FIG. 12). According to the above, the controller 22c regulates the movement of the vehicle 20 when the accelerator pedal 33 is pressed down. Thus the vehicle 20 avoids colliding with an object in the parking lot 12 more reliably than a conventional one.

### Other Embodiments

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure. While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure. For example, the other embodiments are also available to embody the present disclosure.

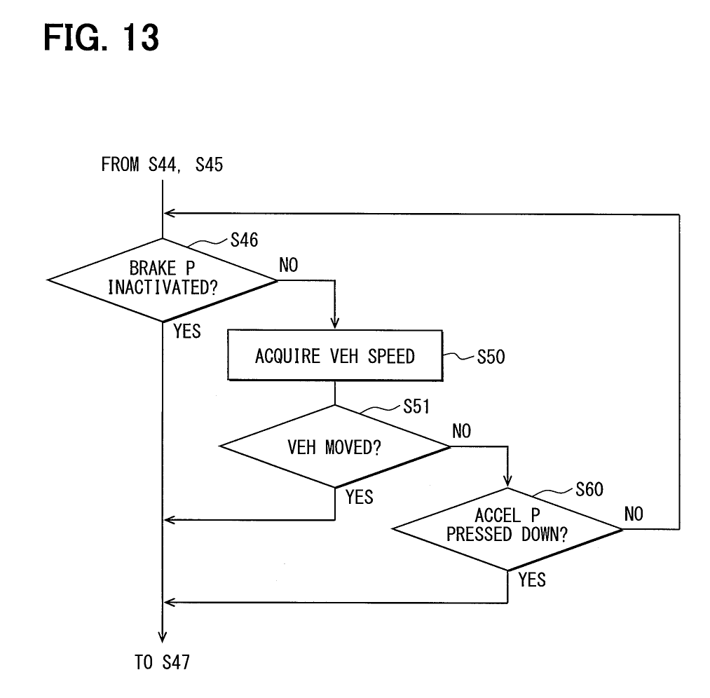

In the above-described first embodiment, the driving controller 22c regulates the movement of the vehicle 20 when the accelerator pedal 33 is not pressed down (S46 and S48 in FIG. 6). In the second embodiment, the driving controller 22c regulates the movement of the vehicle 20 when the vehicle 20 is determined to move based on the acquired speed signal (S50, S51, and S48 in FIG. 11). In the third embodiment, the driving controller 22c regulates the movement of the vehicle 20 when the accelerator pedal 33 is pressed down (S60 and S48 in FIG. 12). Alternatively, as shown in FIG. 13, the driving controller 22c may regulate the movement of the vehicle 20 when the vehicle 20 moves in the prohibited direction and if it is met at least one of the following criteria: a) the accelerator pedal 33 is not pressed down (S46); b) the vehicle 20 is determined to move based on the acquired speed signal (S50, 51); and c) the accelerator pedal 33 is pressed down (S60). These three criteria have no particular order and it is not restricted to the sequence order as shown in FIG. 13. The above provides the same effect as described in (12a), (12b), and (12c).

In the above-described first through third embodiments, as the regulation of the movement of the vehicle 20, the controller 22c transmits a brake data Cb to a brake device 24 to activate brake actuators. Alternatively, it may be optional to control seatbelts tightly in order to soften the shock caused by sudden stop of the vehicle 20 with braking. It may be achieved to prevent or minimize the body effect to the passengers caused by reaction of the sudden stop.

In the above-described first through third embodiments, as the control devices, a plurality of ECU 101, 103, and 104 is installed in the vehicle 20 as shown in FIG. 3. Alternatively, only a singular of ECU or only a singular of computer may also be installed in the vehicle 20. The difference is merely in the processing, distributed or centralized, so the same effect as the first through third embodiments may be given accordingly.

In the above-described first through third embodiments, the system is applied to the vehicle 20 as a four-wheeled vehicle as shown in FIG. 3. Alternatively, the system is applied to a four-wheeled vehicle other than the passenger vehicle such as a freight vehicle or a special vehicle. Moreover, two-wheeled vehicle such as a motorcycle and a multi-wheeled vehicle such as a tractor may also be applied. The same effect as the first through third embodiments may be given whichever the vehicle 20 is, because the movement of any kinds of vehicle 20 may be regulated according to the present disclosure.

In the above-described first embodiment, the accelerator pedal 33 (S46 and S48 in FIG. 6), the movement of the vehicle 20 (S50, S51, and S48 in FIG. 11), and the accelerator pedal 33 (S60 and S48 in FIG. 12) are taken account into the present disclosure. Alternatively, a microphone may be installed in the cabin of the vehicle 20 to collect voices of the occupants, and a determination may be made whether the criteria are met to control the vehicle 20 based on the frequency of the collected voices. Human's voices tend to be at high frequency under an emergency rather than under a normal situation. Thus, the voices in the normal situation are recorded to the memory 22a. The erroneous operation is determined when the higher frequency voices are detected rather than that under the normal situation and S48 as shown in FIGS. 6, 11, and 12 is performed to regulate the movement of the vehicle 20. Therefore, the same effect as the first through third embodiments may be given by the determination based on the voice frequency.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A device for controlling a vehicle moving around a parking lot and for communicating a signal with a facility transceiver placed on the parking lot, comprising:
a vehicle transceiver installed in the vehicle that transmits the signal to the facility transceiver and receivers the signal from the facility transceiver;
a determiner that determines a prohibited direction based on the signal communicated between the facility transceiver and the vehicle transceiver prior to a parking maneuver in the parking lot; and
a controller that regulates a movement of the vehicle if the vehicle is in the prohibited direction.

2. The device for controlling vehicle according to claim 1, wherein
the facility transceiver further comprises a switching unit that switches a power mode between a normal power mode and a lower power mode, wherein
the normal power mode is responsible to be continued for a time period from receiving the signal from the vehicle transceiver until finishing transmitting the signal to the vehicle transceiver, wherein
the lower power mode is responsible for enabling receiving the signal from the vehicle transceiver with a power lower than that of the normal power mode.

3. The device for controlling vehicle according to claim 1, wherein the facility transceiver further comprises at least one of a receiver booster that boosts the signal received from the vehicle transceiver and a transmitter booster that boosts the signal to be transmitted to the vehicle transceiver.

4. The device for controlling vehicle according to claim 1, wherein the vehicle transceiver varies an output of the signal to be transmitted to the facility transceiver.

5. The device for controlling vehicle according to claim 1, wherein the determiner starts communication of the signal between the vehicle transceiver and the facility transceiver after a shifter of the vehicle is positioned at Park or Neutral.

6. The device for controlling vehicle according to claim 1, wherein the determiner puts a vehicle identifying code in the signal communicated with the facility transceiver.

7. The device for controlling vehicle according to claim 6, wherein the determiner identifies the vehicle based on an authentication of the vehicle identifying code between a transmitted signal and a received signal.

8. The device for controlling vehicle according to claim 1, wherein the signal communicated between the vehicle transceiver and the facility transceiver includes an error detecting code.

9. The device for controlling vehicle according to claim 1, wherein the determiner determines the prohibited direction when an ignition switch turns on after the parking maneuver.

10. The device for controlling vehicle according to claim 1, wherein the controller warns the driver.

11. The device for controlling vehicle according to claim 1, wherein the controller regulates the movement of the vehicle if the shifter is positioned at a position corresponding to the prohibited direction.

12. The device for controlling vehicle according to claim 11, wherein the controller regulates the movement of the vehicle when at least one of a brake pedal is inactivated or the vehicle speed is higher than 0 km/h.

13. The device for controlling according to claim 11, wherein the controller regulates the movement of the vehicle when an accelerator pedal is pressed down.

14. The device for controlling according to claim 11, wherein the controller activates a brake actuator that brakes the movement of the vehicle.

15. The device for controlling vehicle according to claim 14, wherein the controller increases a magnitude of braking according to an increase in manipulation at the accelerator pedal.

16. The device for controlling vehicle according to claim 11, wherein the controller regulates the movement of the vehicle based on determination of the determiner when the ignition switch turns on.

17. A system for controlling a vehicle moving around a parking lot, comprising:
a facility transceiver placed on the parking lot that transmits and receives a signal;
a vehicle transceiver installed in the vehicle that transmits and receives the signal;
a determiner that determines a prohibited direction based on the signal communicated between the facility transceiver and the vehicle transceiver prior to a parking maneuver in the parking lot when recognizing the vehicle; and
a controller that regulates a movement of the vehicle if the vehicle is in the prohibited direction.
